(19) United States
(12) Patent Application Publication
(10) Pub. No.: US 2025/0245667 A1
(43) Pub. Date: Jul. 31, 2025

(54) TRUSTED VALIDATION AGENT PLATFORM

(71) Applicant: Wells Fargo Bank, N.A., San Francisco, CA (US)

(72) Inventors: Jim Scott Berry, Gilbert, AZ (US); Kourtney Eidam, Marietta, GA (US); Joseph Christopher Impinna, Mesa, AZ (US); Joseph Michael Korchmar, Concord, NC (US); Michael James Lyon, Everett, WA (US); Nilesh K. Shah, Mooresville, NC (US); Marc R. Ward, Livermore, CA (US)

(21) Appl. No.: 18/428,743

(22) Filed: Jan. 31, 2024

(51) Int. Cl. G06Q 20/40

(52) U.S. Cl. CPC G06Q 20/4016

(57) ABSTRACT

Systems and techniques for trusted validation agent platform are described herein. A transaction is detected as potentially fraudulent based on user profile data of a user. A trusted validation agent is determined for the transaction using the user profile data. Remediation instructions are generated for the trusted validation agent using transaction data of the transaction. The remediation instructions are transmitted to the trusted validation agent. A disposition is determined for the transaction based on input received from the trusted validation agent. Transaction handling instructions are transmitted to a transaction processing system based on the disposition.

### TECHNICAL FIELD

Embodiments described herein generally relate to electronic fraud detection and, in some embodiments, more specifically to a trusted validation agent platform for detecting and remediating electronic fraud attempts.

### BACKGROUND

Customers of financial institutions have long been targets of fraudulent activities, with fraudsters continually developing new methods to exploit vulnerabilities in transaction processing systems. Conventional fraud detection systems rely on rule-based algorithms that flag transactions based on predefined criteria, such as transaction amount thresholds or geographic locations. However, these systems often fail to adapt to the changing behaviors of customers and fraudsters alike, leading to a high rate of false positives and the potential for actual fraudulent transactions to go undetected. Moreover, the conventional fraud detection systems do not account for the varying levels of technological proficiency among customers, which can leave certain groups, such as the elderly, more susceptible to fraud. While some solutions have incorporated one-time passcodes and two-factor authentication methods, these can be circumvented by sophisticated phishing attacks and social engineering tactics.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for a trusted validation agent platform, according to an embodiment.

FIG. 2 illustrates an example machine learning component for configuration option recommendation selection for a trusted validation agent platform, according to an embodiment.

FIG. 3 illustrates an example of a process for a trusted validation agent platform, according to an embodiment.

FIG. 4 illustrates an example of a method for a trusted validation agent platform, according to an embodiment.

FIG. 5 is a block diagram illustrating an example of a machine upon which one or more embodiments may be implemented.

### DETAILED DESCRIPTION

Customers of a financial organization may be targets of fraudulent activities. As fraud attempts become more advanced through the use of artificial intelligence, social engineering, etc., the pool of vulnerable customers continues to increase. Sophisticated fraud attempts may fool a wide range of customers having average or above technical knowledge and with no underlying mental deficiencies. Conventional transaction monitoring and fraud detection may fail to adapt to evolving tactics of fraudsters, leaving certain customer segments, such as the elderly or those less familiar with technology, and even customers of above average mental acuity and technical ability at heightened risk. Conventional transaction monitoring and fraud detection techniques may not adequately capture the nuances of individual customer behavior and are limited in their ability to prevent fraud before it occurs. Conventional techniques lack personalized intervention that may assist customers in real-time during potentially fraudulent transactions. This gap in fraud detection necessitates a more dynamic, intelligent, and customer-centric approach to fraud prevention. For example, refund scams may involve debiting an account being funded via an online transfer from another account to trick the customer into thinking that they are getting a refund.

The proposed solution is a trusted validation agent platform that leverages machine learning (ML) and artificial intelligence (AI) to enhance transaction protection for customers. The trusted validation agent platform proactively identifies transaction types and limits that should be protected based on financial behavior of a customer and peer data from similarly situated customers. In the case of high value/high risk transactions, the trusted validation agent platform provides a more seamless way to add protection to payment services to prevent money apps from being leveraged by fraudsters. Recommendations are provided for customers to opt-in for additional scrutiny on high-value, high-risk, or rarely used transactions. When a protected action is initiated, the trusted validation agent platform prompts a trusted validation agent—selected based on relationship data or a list of trusted third-party providers—to review the transaction before completion. This intervention allows for a more personalized and informed decision-making process, effectively preventing the completion of fraudulent activities. The system also incorporates a feedback loop, where the learning model adapts to new data and customer feedback, ensuring continuous improvement and up-to-date protection measures. The trusted validation agent platform thus offers a customer-focused solution to the problem of financial fraud, significantly enhancing security and integrity of financial transactions.

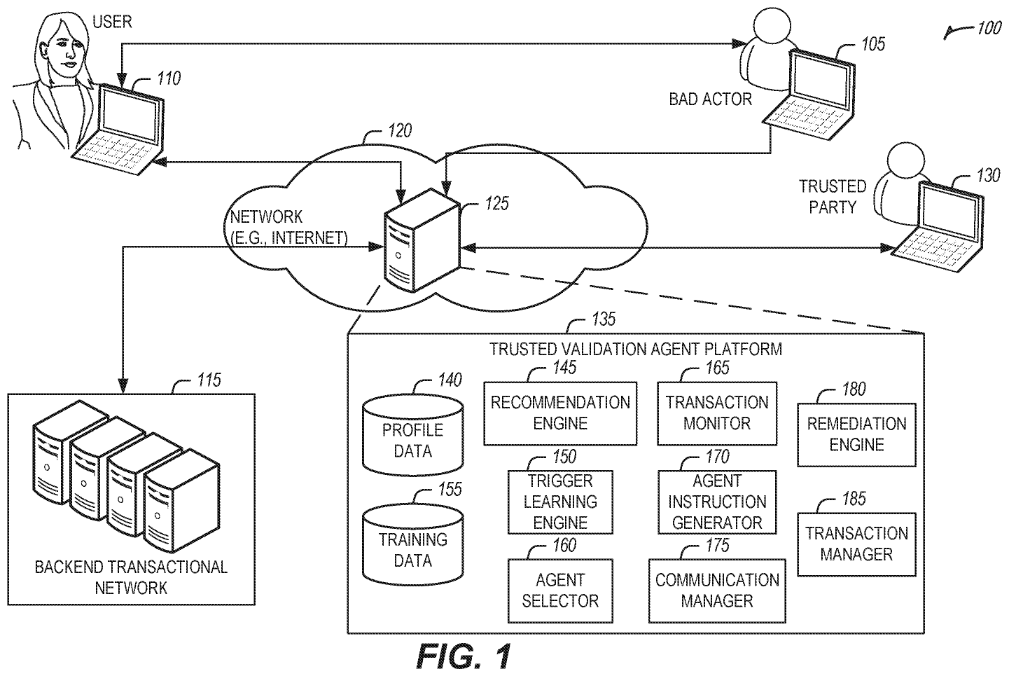

FIG. 1 is a block diagram of an example of an environment 100 and a system 135 for a trusted validation agent platform, according to an embodiment. The environment 100 includes a bad actor computing device 105 (e.g., a laptop, a desktop, a smartphone, a tablet, etc.) that is used by a bad actor to facilitate a fraudulent act using a user computing device 110 of a user (e.g., a customer of a financial institution, etc.) by requesting the user initiate a transaction with a backend transactional network 115 (e.g., a banking network, a brokerage network, a payment network, etc.). The initiated transaction flows through or is observed by a server computing device 125 (e.g., a standalone server computing device, a cloud computing platform, a distributed computing platform, a virtualized computing platform, a field programmable gate array (FPGA), a system on chip (SoC), an application specific integrated circuit (ASIC), etc.) communicatively coupled (e.g., via a network 120) to the backend transactional network 115 and a device used to initiate the transaction (e.g., the user computing device 110, bad actor computing device 105, etc.). The server computing device 125 includes the system 135 that may trigger transmission of details of the transaction to a trusted party computing device 130 before the transaction is allowed to progress.

In an example, the system 135 may be a trusted validation agent platform. The system 135 may include a variety of components including profile data 140 of the user, a recommendation engine 145, a trigger learning engine 150, training data 155, an agent selector 160, a transaction monitor 165, an agent instruction generator 170, a communication manager 175, a remediation engine 180, and a transaction manager 185.

The recommendation engine 145 proactively makes recommendations to customers regarding transaction types and limits they should protect using a trusted validation agent based on data present in the profile data 140 (e.g., transactional data, account history, fraud history, account portfolio, etc.). For example, the suggested transaction types or amount may represent high value transactions or high risk actions. Recommendations may be made based on transaction vacancy (e.g., no wire transfers, etc.) in the customer profile data 140 or in profile data of users that are similarly situated (e.g., present in the training data 155, etc.), activities to monitor based on user behavior, etc.

The trigger learning engine 150 uses training data 155 that includes historical customer account activity, fraud history, etc. to extract features to build a recommendation model for recommended trusted validation agent triggers that may be recommended to the user based on fraud experiences and trigger preferences of other customers with features similar to the user. For example, recurrent transaction data, name code, category code, amounts or transactions that resulted in previous fraud, dormancy, etc. may be used as features for generating the recommendation model. The recommendation model may be generated based on peer data for similarly situated customers or locations with high incidents of fraud (e.g., frequency of fraud at a particular gas station frequented by the user, etc.). Deposit information may be correlated to identify when a customer is more vulnerable to fraud (e.g., when more cash is available, etc.) to adjust recommendations or trigger sensitivity (e.g., altering closeness of match, sampling frequency, etc.). Multiple data points are used to make recommendations using the recommendation model. The recommendation engine 145 uses the recommendation model generated by the trigger learning engine 150 to make recommendations to the user. The recommendations provided to the user change over time based on progression of a financial journey of the user and additional feedback revisions made to the recommendation model.

The trigger learning engine 150 may use AI to learn trigger events from across accounts. Customer preferences may be learned and the user may opt-in to anomaly detection that identifies transactions that may not have been initiated by the user. Historical user transaction data including financial history may be used to perform behavior-based detection of anomalous transactions that may trigger initiation of a trusted validation agent session. Data from a threat database may be evaluated to identify trending attacks to create validation agent session trigger events. For example, a user may opt-in to account monitoring and features of user transactions may be compared to features of trending threats from the threat database. Transactions of the user may be monitored to look for fraud campaigns to notify the user of general attacks or actually attacks based on fraud. If matching features are outside a threshold, a trusted validation agent session may be initiated for the transaction. Transactions may include, by way of example and not limitation, money transfers, purchase transactions, check requests, wire transfers, automated clearing house payment requests, security trades, etc. In an example, the user may identify trusted merchants, payees, transactions, etc. that should be ignored or weighted towards non-fraud. This allows the user to designate high-priority transactions that should be generally trusted to proceed. For example, payments to a mortgage holding financial institution of the user may be marked as trusted to prevent the mortgage payment from being delayed due to triggering a trusted validation agent session. The user may provide granular rules for designating trusted transactions. For example, all payments to the mortgage company may be trusted, only payments of a certain amount may be trusted, only payments occurring on a specific data may be trusted, etc.

The agent selector 160 provides an interface to the user to select a person or entity to be designated as the trusted validation agent. Upon user initiation, the agent selector 160 may provide recommendations for a trusted validation agent based similar profiles (e.g., a similarly situated customer) or based on relationship information (e.g., a child of the user, a parent of the user, an employee of a bank that the user regularly works with, a third party trusted validation service provider, etc.) from the user profile data 140. A list of potential trusted validation agents may be provided based on the relationship data, a list of trusted validation provided by 3rd parties (e.g., a trust company, financial institution, etc. The user may also manually designate an unlisted trusted validation agent (e.g., a relative, friend, etc.). When a user add a trusted validation agent, a notification is transmitted to the trusted validation agent with an indication of the role/permissions provided and an identification of the user. This enables the trusted validation agent to accept or deny the request and, if accepted, to be on notice that the trusted validation agent may be notified of future transactions.

The agent selector 160 may enable the user to assign various types of validation agents/roles using templates that define granular data release for the various types/roles, when a transaction triggers the validation agent, etc. In an example, the user may be presented with an option to select an automatic agent that uses a chatbot and a large language model (LLM) to act as a validation agent that is able to make a final deposition decision for a transaction based on transmitting clarifying queries to the user and processing the received responses using the available transaction data and the LLM. The chatbot may generate a template for an agent to use in discussing the transaction with the user. In an example, the chatbot may be the initial point of contact for the trusted validation agent session and the session may be transferred to a human validation agent (e.g., when additional information is needed, when the basic information has been collected, etc.).

A trusted validation agent may have a mixed role with notification for some transactions and transactional role for other transactions where the notifications provide the trusted validation agent an opportunity to intervene by contacting the user and the transactional role requests the trusted validation agent to act to approve or deny the transaction based on results of the session. These roles are set by the user and may be configured based on transaction type, fraud type, etc. for each trusted validation agent.

User input received from the recommendation engine 145 and the agent selector 160 are stored in the user profile data 140. The transaction monitor 165 monitors transactions initiated for the accounts of the user using the trigger options selected by the user (e.g., as stored in the user profile data 140) to identify transactions that trigger initiation of a communication flow (e.g., based on features of the transaction matching or being similar to features of a selected trigger, etc.) with the trusted party computing device 130. The transaction monitor 165 works in conjunction with the agent instruction generator 170 to generate guidance instructions for transmission to the trusted party computing device 130 based on details of the transaction and privacy controls configured by the user. The user, when selecting agents or recommended triggers, is provided with detail level options that allow the customer to determine how much transactional data is provided to a trusted validation agent or a specific trusted party. For example, the user may allow a sibling trusted party to see only the type of transaction and not a specific amount of the transaction and may allow an employee of a financial institution designated as a trusted party to see all details of the transaction including the amount of the transaction.

Based on the transaction information and the transactional detail allowed by the user, the agent instruction generator 170 compiles a set of instructions for the trusted validation agent to use in communicating with the user. For example, the transaction may indicate the possible presence of a refund scam and the instructions may be generated that include a brief description of a refund scam, the transaction details that make the transaction appear to be a refund scam, and discussion points for the trusted validation agent to discuss with the user to determine if the transaction is legitimate or if the transaction is a likely refund scam. In an example, the set of instructions may include third party information such as a website of a transaction end point, an email address of an initiator of the transaction, etc. The trusted validation agent is provided with data-based guidance that may include questions to ask or a script generated from the customer data and transaction type and details. For example, there may be standard questions that a claims department uses to extract information from customers suspected of falling for scams. For example: “Were you contacted by someone claiming to be X?”, “Were you told that you were getting money back?”, “Were you asked to send funds back?”, “Were you contacted by someone claiming to be from the bank?”, etc. The questions or script included in the validation agent instructions is designed to help the customer realize that they might be a victim of a scam and for the validation agent to understand the circumstances of the subject transaction more fully. The instructions educate the trusted validation agent regarding what to look for to help make their decisions more effective.

The agent instruction generator 170 transmits the agent instructions to the communication manager 175. The communication manager 175 initiates a communication session for the user and the trusted party and transmits the agent instructions to the trusted party computing device 130. The communication session enables two-way communication between the user and the trusted party to allow discussion of the transaction. The customer may be notified that the transaction is under review. In an example, two-party integrity may be used where two text messages (e.g., one-time passcodes) are transmitted to different devices (e.g., the customer and the trusted validation agent) and must be combined to complete the transaction. In another example, certain user defined activities and transactions may be monitored to validate that the transaction is legitimate. In an example, a smart contract may be used in conjunction with profile info to determine if a user making a transaction is the rightful owner of the account. An ML-based transaction protection mechanism may be used to generate a transaction context-based script for use by the trusted validation agent based on features of the triggering transaction.

The remediation engine 180 presents a user interface to the trusted party in the communication session requesting feedback regarding the transaction. For example, the trusted party may be asked if the transaction is fraudulent, is not fraudulent, or unknown. In an example, the queries by the remediation engine may be associated with portions of the agent instructions. The remediation engine 180 receives the input from the trusted party and determines whether the transaction should be allowed to proceed. In an example, the remediation engine 180 may use a binary, decision tree, rules-based, or various other forms of decision making logic to decide as to whether the transaction should proceed. During agent selection using the agent selector 160, the user is prompted to provide options for how decision making is conducted by the remediation engine 180. For example, the user may indicate that the trusted validation agent may provide input, by the user may override any decision made by the trusted validation agent, that the decision of the trusted validation agent is controlling, that a cooling off period be established before a final decision is made for disposition of the transaction, etc. This provides the user with ultimate control over how potentially fraudulent transactions are remediated. In an example, the trusted validation agent may decline to approve the transaction and the remediation engine 180, in conjunction with the transaction manager 185, may decline the transaction or send the transaction back to the user with information regarding why the transaction was not approved by the trusted validation agent. At that point, the user may continue the transaction (e.g., with the assistance of a representative of the financial institution, etc.) or may allow the transaction to expire.

When a final disposition of the transaction is determined by the remediation engine 180, the transaction manager 185 works in conjunction with the backend transactional network 115 to facilitate processing of the transaction whether that be to continue or terminate the transaction. The transaction manager 185 may also work in conjunction with the transaction monitor 165 to instruct the backend transactional network 115 to paus processing of the transaction until a final disposition is determined by the remediation engine 180. For example, a delay of 48 hours may be transmitted to the backend transaction network 115 to pause the transaction for 48 hours with the transaction being in a paused state until a final disposition is received or the 48 period elapses. The pause may prevent transactions from automatically being abandoned and cancelled due to unresponsiveness in the communication session. The settings may be set by the user in the user profile data 140 allowing the user to determine if transactions should proceed if no remediation deposition is received or should be cancelled by default if no remediation disposition is received. In an example, a transaction may not be canceled, but a hold may be extended to provide the user more time to investigate the transaction.

The user may opt-in to protection for certain transaction types, transaction contexts, etc. and when a protected action is initiated, the trusted validation agent is asked to review the transaction before completion providing an additional level of protection for the user against fraud. Completion of the activity is delayed until the trusted validation agent is provided an opportunity to review the transaction. The user may change or opt out of the trusted validation platform at any time. However, a waiting period may be implemented to prevent a would be fraudster from thwarting the protection provided. For example, the user may opt out, but the trusted validation agent may continue to provide validation for 72 additional hours.

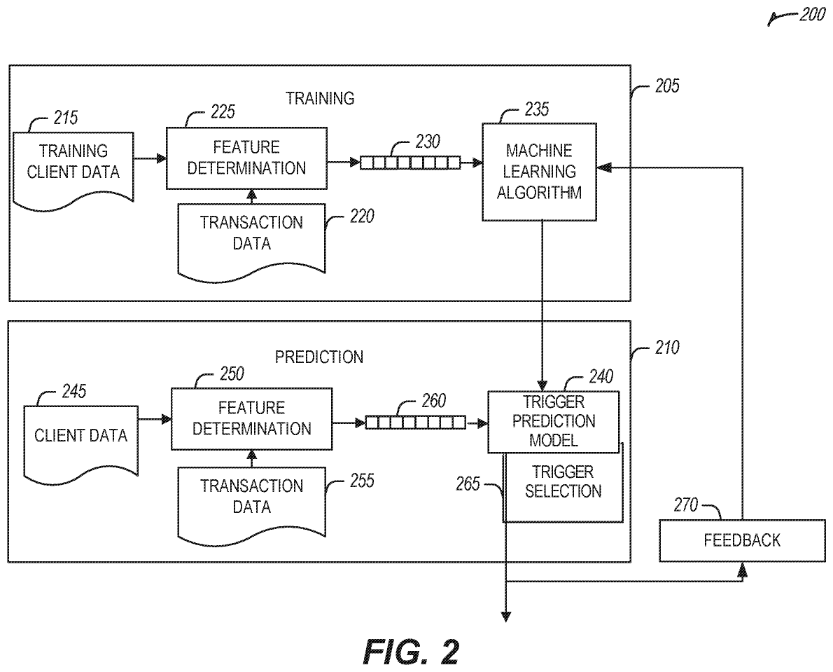

FIG. 2 illustrates an example machine learning component 200 for configuration option recommendation selection for trusted validation agent platform, according to an embodiment. The machine learning component 200 may be a component of the system 135 such as the trigger learning engine 150 as described in FIG. 1 and may be used in conjunction with the recommendation engine 145, the agent selector 160, agent instruction generator 170, etc. as described in FIG. 1. The machine learning component utilizes a training module 205 and a prediction module 210. Training module 205 feeds training client data 215 and transaction data 220 into feature determination module 225 which determines one or more features 230 from this information. Features 230 are a subset of the information input and is information determined to be predictive of transaction triggers for a client based on previously triggering transactions for similarly situated clients (e.g., having similar client data, etc.). Examples include one or more of client type, relationship data, client product and service mix, client demographics, etc.

The machine learning algorithm 235 produces a trigger prediction model 240 based upon the features and feedback 270 associated with those features. For example, the features associated with past triggering transactions for past clients are used as a set of training data. As noted above, the trigger prediction model 240 may be for the entire system (e.g., built of training data accumulated throughout the entire system, regardless of the user for which a resource is being selected), or may be built specific for each user, user group, project type, file type, etc.

In the prediction module 210, the current client data 245 (e.g., data describing the current client, etc.) may be input to the feature determination module 250. Similarly applicable client transaction data 255 is also input to the feature determination module 250. Feature determination module 250 may determine the same set of features or a different set of features as feature determination module 225. In some examples, feature determination module 250 and 225 are the same module. Feature determination module 250 produces features 260, which are input into the trigger prediction model 240 to requirements selection 265. The training module 205 may operate in an offline manner to train the trigger prediction model 240. The prediction module 210, however, may be designed to operate in an online manner as each set of client data is evaluated as transactions occur.

It should be noted that the trigger prediction model 240 may be periodically updated via additional training and/or user feedback 270. The user feedback 270 may be feedback from users that provide explicit feedback (e.g., responses to questions about whether a transaction should have triggered a trusted validation agent session, etc.) or may be automated feedback 270 based on outcomes of the triggering transaction for the client. For example, a user that had a transaction trigger a trusted validation agent session may provide an explicit response indicating that the trusted validation agent session was not necessary or a staff member of an organization may provide the feedback during review of the transaction and the response may be used as additional training data for updating the trigger prediction model 240.

The machine learning algorithm 235 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, and hidden Markov models. Examples of unsupervised learning algorithms include expectation-maximization algorithms, vector quantization, and information bottleneck method. In an example embodiment, a multi-class logistical regression model is used.

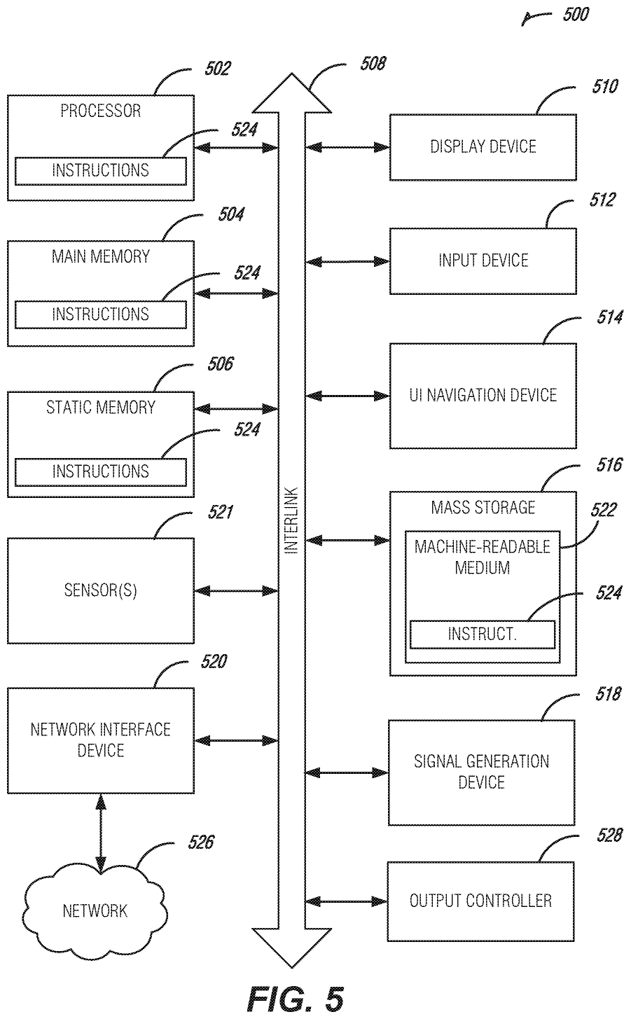

The system 135 as described in FIG. 1 and the machine learning component 200 may be implemented on one or more computing devices, such as machine 500 of FIG. 5. As such, some of the components of FIG. 1 may communicate with each other via inter-process communication and other local communications techniques (e.g., shared memory, pipes, buffers, queues). In other examples, the components of FIG. 1 may be parts of different services or systems and thus the components may communicate with each other through a computer network using computer networking protocols.

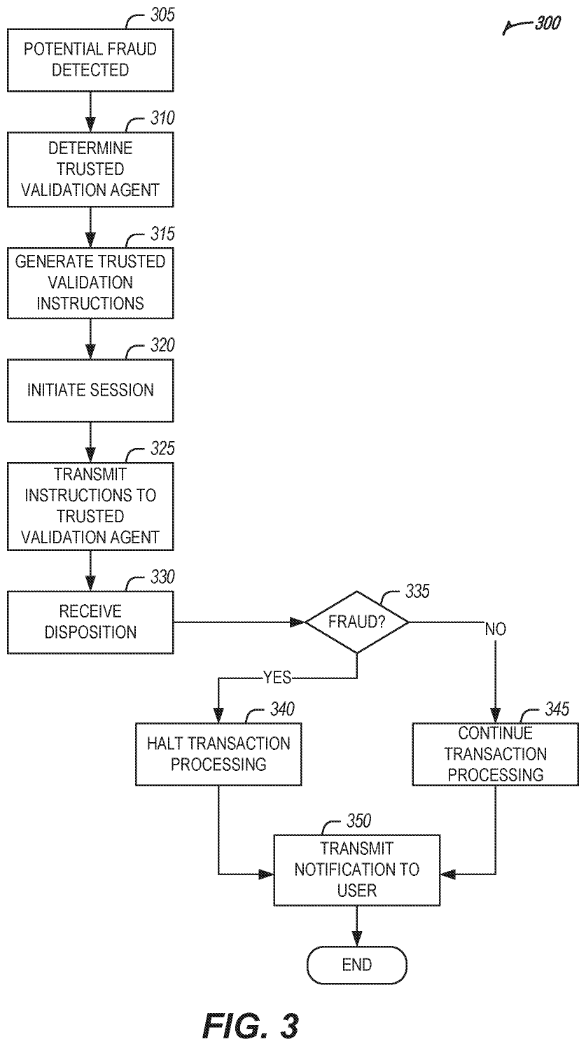

FIG. 3 illustrates an example of a process 300 for a trusted validation agent platform, according to an embodiment. The process 300 may provide features as described in FIGS. 1 and 2.

At operation 305, a potentially fraudulent transaction is detected based on options set by a user. At operation 310, a trusted validation agent (as selected by the user) is determined to receive a trusted validation agent message. In an example, the trusted validation agent may be selected from a list of trusted validation agents selected by the user based on characteristics of the transaction.

At operation 315, instructions are generated for the trusted validation agent based on transaction data and preferences set by the user indicating a level of data granularity or permissions for the trusted validation agent. In an example, third party data may be obtained and included in the instructions. At operation 320, a communication session is initiated between the trusted validation agent and the user. In an example, the communication session may be initiated via text message, email, telephone, chat, etc. At operation 325, the instructions are transmitted to a computing device of the trusted validation agent. In an example, the instructions may be presented in the communication session.

At operation 330, at conclusion of the session, a disposition is received from the trusted validation agent. For example, the trusted validation agent may be presented with a prompt asking whether or not the transaction appears to be fraudulent. At decision 335, it is determined in remediation whether the transaction appears to be actual fraud. If yes, the transaction is halted at operation 340 by canceling, pausing, or taking some other action or inaction on the transaction. If it is determined that the transaction does not appear to be actual fraud, the transaction is allowed to continue processing at operation 345.

At operation 350, a notification is transmitted to the user indicating the status of the transaction. For example, the user may be sent a message indicating that the transaction was canceled, paused, successful, etc. In an example, a similar notification may be transmitted to the trusted validation agent.

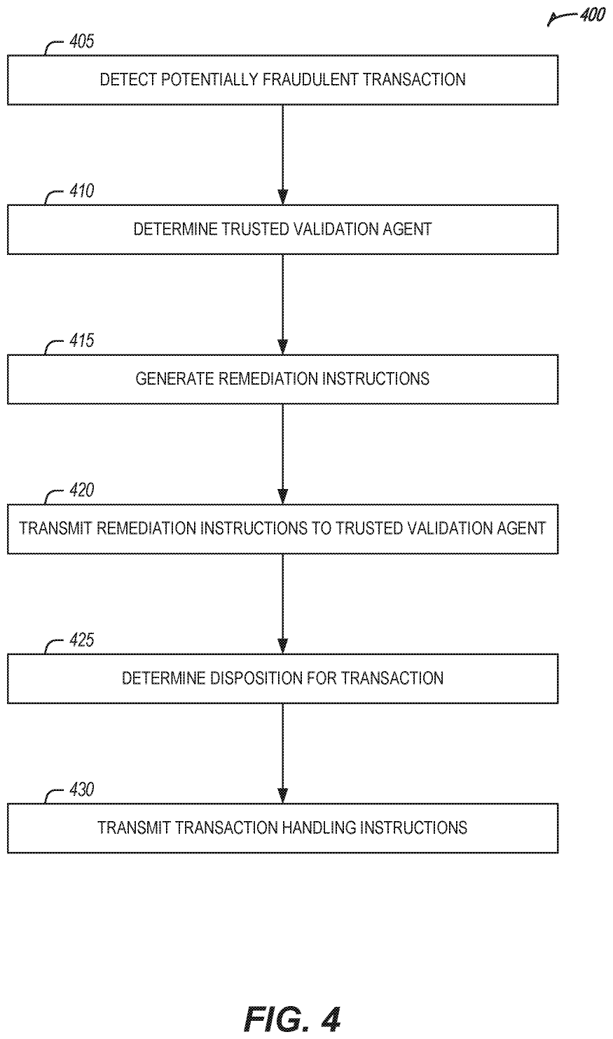

FIG. 4 illustrates an example of a method 400 for a trusted validation agent platform, according to an embodiment. The method 400 may provide features as described in FIGS. 1 to 3.

A transaction is detected as potentially fraudulent based on user profile data of a user (e.g., at operation 405). The transaction is associated with the user. In an example, a triggering transaction prediction model may be trained by extracting features from historical client data and historical transaction data that includes fraudulent transactions. Profile data and transaction data of the user may be evaluated using the triggering transaction prediction model to generate a list of transaction types likely to trigger a trusted validation agent session. The list may be presented to the user in a user interface including user interface elements for selection of one or more transaction types. The user profile data may be updated based on activation of one or more of the user interface elements and the transaction may be determined to be potentially fraudulent as being associated with one or more transaction types stored in the user profile data.

A trusted validation agent is determined for the transaction using the user profile data (e.g., at operation 410). In an example, the trusted validation agent may be determined by selecting the trusted validation agent from a list of trusted validation agents stored in the user profile data. The trusted validation agent may be selected in part based on attributes of the transaction.

Remediation instructions are generated for the trusted validation agent using transaction data of the transaction (e.g., at operation 415). In an example, the remediation instructions may include a script generated based on the transaction data and a fraud type associated with the transaction.

The remediation instructions are transmitted to the trusted validation agent (e.g., at operation 420). A disposition is determined for the transaction based on input received from the trusted validation agent (e.g., at operation 425). In an example, the trusted validation agent may be a chatbot and the chatbot may query a large language model with the remediation instructions. A list of questions may be received to be presented to the user to be used in determining if the transaction is fraudulent. The list of questions may be transmitted to the user. Input may be received from the user in response to transmission of the list of questions. The input may be transmitted to the large language model and the disposition may be determined using output received from the large language model.

Transaction handling instructions are transmitted to a transaction processing system based on the disposition (e.g., at operation 430). The transaction handling instructions cause the transaction processing system to alter processing of the transaction. In an example, alteration of the processing of the transaction may be to insert a pause or other delay in the transaction processing instructions to provide time for interaction between the user and the trusted validation agent. In an example, the disposition may indicate the transaction is fraudulent and the transaction handling instructions may cancel processing of the transaction based on user preferences in the user profile data. In an example, the disposition may indicate the transaction is fraudulent and the transaction handling instructions may pause processing of the transaction based on user preferences in the user profile data. In an example, the disposition may indicate the transaction is not fraudulent and the transaction handling instructions may continue processing of the transaction.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensors. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for a trusted validation agent platform comprising:
at least one processor; and
memory comprising instructions that, when executed by the at least one processor, cause the at least one processor to perform operations to:
detect that a transaction is potentially fraudulent based on user profile data of a user, wherein the transaction is associated with the user;
determine a trusted validation agent for the transaction using the user profile data;
generate remediation instructions for the trusted validation agent using transaction data of the transaction;
transmit the remediation instructions to the trusted validation agent;
determine a disposition for the transaction based on input received from the trusted validation agent; and
transmit transaction handling instructions to a transaction processing system based on the disposition, wherein the transaction handling instructions cause the transaction processing system to alter processing of the transaction.

2. The system of claim 1, the memory further comprising instructions that, when executed by the at least one processor, cause the at least one processor to perform operations to:
train a triggering transaction prediction model by extracting features from historical client data and historical transaction data that includes fraudulent transactions;
evaluate profile data and transaction data of the user using the triggering transaction prediction model to generate a list of transaction types likely to trigger a trusted validation agent session;
present the list to the user in a user interface including user interface elements for selection of one or more transaction types; and
update the user profile data based on activation of one or more of the user interface elements, wherein the transaction is determined to be potentially fraudulent as being associated with one or more transaction types stored in the user profile data.

3. The system of claim 1, the instructions to determine the trusted validation agent further comprising instructions that, when executed by the at least one processor, cause the at least one processor to perform operations to:
select the trusted validation agent from a list of trusted validation agents stored in the user profile data in part based on attributes of the transaction.

4. The system of claim 1, wherein the remediation instructions include a script generated based on the transaction data and a fraud type associated with the transaction.

5. The system of claim 1, wherein the disposition indicates the transaction is fraudulent and the transaction handling instructions cancel processing of the transaction based on user preferences in the user profile data.

6. The system of claim 1, wherein the disposition indicates the transaction is fraudulent and the transaction handling instructions pause processing of the transaction based on user preferences in the user profile data.

7. The system of claim 1, wherein alteration of the processing of the transaction is a delay, wherein the disposition indicates the transaction is not fraudulent, and the transaction handling instructions continue processing of the transaction by ending the delay.

8. The system of claim 1, wherein the trusted validation agent is a chatbot and the memory further comprising instructions that, when executed by the at least one processor, cause the at least one processor to perform operations to:
query a large language model with the remediation instructions;
receive a list of questions to be presented to the user to be used in determining if the transaction is fraudulent;
transmit the list of questions to the user;
receive input from the user in response to transmission of the list of questions; and
transmit the input to the large language model, wherein the disposition is determined using output received from the large language model.

9. At least one non-transitory machine-readable medium comprising instructions for a trusted validation agent platform that, when executed by at least one processor, cause the at least one processor to perform operations to:
detect that a transaction is potentially fraudulent based on user profile data of a user, wherein the transaction is associated with the user;
determine a trusted validation agent for the transaction using the user profile data;
generate remediation instructions for the trusted validation agent using transaction data of the transaction;
transmit the remediation instructions to the trusted validation agent;
determine a disposition for the transaction based on input received from the trusted validation agent; and
transmit transaction handling instructions to a transaction processing system based on the disposition, wherein the transaction handling instructions cause the transaction processing system to alter processing of the transaction.

10. The at least one non-transitory machine-readable medium of claim 9, further comprising instructions that, when executed by the at least one processor, cause the at least one processor to perform operations to:
train a triggering transaction prediction model by extracting features from historical client data and historical transaction data that includes fraudulent transactions;
evaluate profile data and transaction data of the user using the triggering transaction prediction model to generate a list of transaction types likely to trigger a trusted validation agent session;
present the list to the user in a user interface including user interface elements for selection of one or more transaction types; and
update the user profile data based on activation of one or more of the user interface elements, wherein the transaction is determined to be potentially fraudulent as being associated with one or more transaction types stored in the user profile data.

11. The at least one non-transitory machine-readable medium of claim 9, the instructions to determine the trusted validation agent further comprising instructions that, when executed by the at least one processor, cause the at least one processor to perform operations to:
select the trusted validation agent from a list of trusted validation agents stored in the user profile data in part based on attributes of the transaction.

12. The at least one non-transitory machine-readable medium of claim 9, wherein the trusted validation agent is a chatbot and further comprising instructions that, when executed by the at least one processor, cause the at least one processor to perform operations to:
query a large language model with the remediation instructions;
receive a list of questions to be presented to the user to be used in determining if the transaction is fraudulent;
transmit the list of questions to the user;
receive input from the user in response to transmission of the list of questions; and
transmit the input to the large language model, wherein the disposition is determined using output received from the large language model.

13. A method for a trusted validation agent platform comprising:
detecting that a transaction is potentially fraudulent based on user profile data of a user, wherein the transaction is associated with the user;
determining a trusted validation agent for the transaction using the user profile data;
generating remediation instructions for the trusted validation agent using transaction data of the transaction;
transmitting the remediation instructions to the trusted validation agent;
determining a disposition for the transaction based on input received from the trusted validation agent; and
transmitting transaction handling instructions to a transaction processing system based on the disposition, wherein the transaction handling instructions cause the transaction processing system to alter processing of the transaction.

14. The method of claim 13, further comprising:
training a triggering transaction prediction model by extracting features from historical client data and historical transaction data that includes fraudulent transactions;
evaluating profile data and transaction data of the user using the triggering transaction prediction model to generate a list of transaction types likely to trigger a trusted validation agent session;
presenting the list to the user in a user interface including user interface elements for selection of one or more transaction types; and
updating the user profile data based on activation of one or more of the user interface elements, wherein the transaction is determined to be potentially fraudulent as being associated with one or more transaction types stored in the user profile data.

15. The method of claim 13, wherein the trusted validation agent is determined by selecting the trusted validation agent from a list of trusted validation agents stored in the user profile data, the trusted validation agent selected in part based on attributes of the transaction.

16. The method of claim 13, wherein the remediation instructions include a script generated based on the transaction data and a fraud type associated with the transaction.

17. The method of claim 13, wherein the disposition indicates the transaction is fraudulent and the transaction handling instructions cancel processing of the transaction based on user preferences in the user profile data.

18. The method of claim 13, wherein the disposition indicates the transaction is fraudulent and the transaction handling instructions pause processing of the transaction based on user preferences in the user profile data.

19. The method of claim 13, wherein alteration of the processing of the transaction is a delay, wherein the disposition indicates the transaction is not fraudulent, and the transaction handling instructions continue processing of the transaction by ending the delay.

20. The method of claim 13, wherein the trusted validation agent is a chatbot and further comprising:
querying a large language model with the remediation instructions;
receiving a list of questions to be presented to the user to be used in determining if the transaction is fraudulent;
transmitting the list of questions to the user;
receiving input from the user in response to transmission of the list of questions; and
transmitting the input to the large language model, wherein the disposition is determined using output received from the large language model.
